(19) United States
(12) Patent Application Publication
(10) Pub. No.: US 2018/0321981 A1
(43) Pub. Date: Nov. 8, 2018

(54) SYSTEM AND METHOD FOR SELF ORGANIZING DATA CENTER

(71) Applicant: William Carson MCCORMICK, Ottawa (CA)

(72) Inventor: William Carson MCCORMICK, Ottawa (CA)

(73) Assignee: Huawei Technologies Co., Ltd., Shenzhen (CN)

(21) Appl. No.: 15/792,577

(22) Filed: Oct. 24, 2017

Related U.S. Application Data
(60) Provisional application No. 62/501,352, filed on May 4, 2017.

(51) Int. Cl. G06F 9/50

(52) U.S. Cl. CPC G06F 9/5038; G06F 9/44505; G06F 9/5083; G06F 9/5077

(57) ABSTRACT

A self organizing data center comprising: a plurality of services, each service configured to select and modify its placement; and a plurality of servers, each server configured to select and modify its resource allocation to each placement. A service or service application executing in the data center can request to modify its resource allocation. The data center, upon receiving a request to modify the resource allocation, runs an auction among the services and determines the proposed new resource allocation and its conditions. The service transmits an answer to the data server and if the answer indicates acceptance of the new resource allocation, the data center implements the new resource allocation.

### CROSS-REFERENCE TO RELATED APPLICATIONS

The present invention is based on, and claims benefit of US provisional patent application No. 62/501,352 filed May 4, 2017, the entire content of which is hereby incorporated herein by reference.

### FIELD OF THE INVENTION

The present invention pertains to the field of Computational Networks, and in particular to systems and methods for self organizing data center.

### BACKGROUND

As is well known in the art, a data center is a facility that includes a number of computers and associated components, such as telecommunications, data storage, power management, and cooling systems. Typically, at least the computers, telecommunications systems and data storage systems are interconnected to form a network or cluster of computing resources, which can be allocated to meet customer requirements.

In many cases, a Data Center Provider may allocate resources to a customer in accordance with a Service Level Agreement (SLA) negotiated between the Data Center Provider and the customer. When a customer requires additional, or different, resources, the customer will negotiate a new SLA with the Data Center Provider. While a customer may agree to an SLA that guarantees a defined allocation of computing resources, the customer will typically not be aware of the specific computer(s) telecommunications system(s) and data storage system(s) that may be used to support that allocation. Those details are normally made by the Data Center Provider based on its own criteria, which may include considerations of power efficiency, security, and load balancing. In order to enable optimisation of the allocation of data center resources to customers, the detailed allocation of resources to each customer is almost always handled using a centralized management system.

This background information is provided to reveal information believed by the applicant to be of possible relevance to the present invention. No admission is necessarily intended, nor should be construed, that any of the preceding information constitutes prior art against the present invention.

### SUMMARY

An object of embodiments of the present invention is to provide systems and methods for self organizing data center.

Accordingly, an aspect of the present invention provides a self organizing data center comprising: a plurality of services, each service configured to select and modify its placement; and a plurality of servers, each server configured to select and modify its resource allocation to each placement.

A further aspect of the present invention provides a method of managing a data center, the method comprises: a service executing in the data center requesting a resource allocation from a selected server of the data center; and responsive to the request from the service, the selected server defining a resource allocation and returning a resource allocation result to the service.

Some embodiments further comprise the service selecting the server in accordance with a Stochastic Local Search. In specific embodiments, the selected server may define the resource allocation in accordance with an Algorithmic Game Theory based auction.

### BRIEF DESCRIPTION OF THE FIGURES

Further features and advantages of the present invention will become apparent from the following detailed description, taken in combination with the appended drawings, in which:

FIG. 1 is a block diagram of a computing system that may be used for implementing devices and methods in accordance with representative embodiments of the present invention;

FIG. 2 is a block diagram of a server that may be used for implementing devices and methods in accordance with representative embodiments of the present invention;

FIG. 3 is a block diagram illustrating an example architecture of a data center;

FIGS. 4A and 4B are block diagrams illustrating relationships between Services and Servers in the example architecture of FIG. 3;

FIG. 4C is a block diagram illustrating relationships between Services and Servers in greater detail;

FIG. 5 is a flow-chart illustrating an example process in accordance with embodiments of the present invention;

FIG. 6 is a call-flow diagram illustrating an example process in accordance with embodiments of the present invention;

FIG. 7 is a block diagram illustrating messages exchanged during a resource allocation auction in accordance with embodiments of the present invention;

FIG. 8 is a flow-chart illustrating an example process in accordance with embodiments of the present invention; and

FIG. 9 is a call-flow diagram illustrating an example process in accordance with embodiments of the present invention.

It will be noted that throughout the appended drawings, like features are identified by like reference numerals.

### DETAILED DESCRIPTION

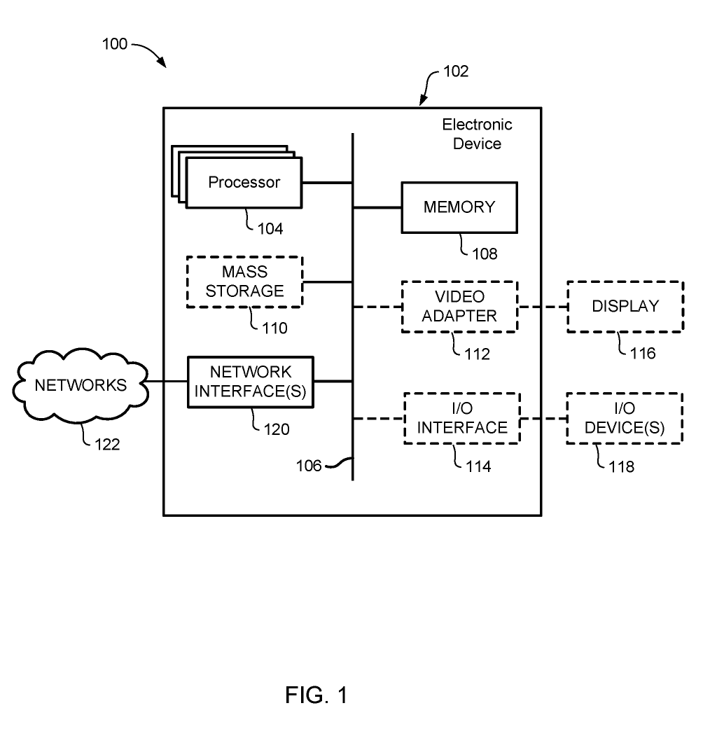

FIG. 1 is a block diagram of a computing and communications system 100 that may be used for implementing the devices and methods disclosed herein. Specific devices may utilize all of the components shown or only a subset of the components, and levels of integration may vary from device to device. Furthermore, a device may contain multiple instances of a component, such as multiple processing units, processors, memories, transmitters, receivers, etc. The computing and communications system 100 includes a processing unit 102. The processing unit 102 typically includes a central processing unit (CPU) 104, a bus 106 and a memory 108, and may optionally also include a mass storage device 110, a video adapter 112, and an I/O interface 114(shown in dashed lines).

In some embodiments, the processing unit 102 may be an element of communications network infrastructure, such as a base station (for example a NodeB, an enhanced Node B (eNodeB), a next generation NodeB (sometimes referred to as a gNodeB or gNB), a home subscriber server (HSS), a gateway (GW) such as a packet gateway (PGW) or a serving gateway (SGW) or various other nodes or functions within an evolved packet core (EPC) network. In other embodiments, the processing unit 102 may be a device that connects to network infrastructure over a radio interface, such as a mobile phone, smart phone or other such device that may be classified as a User Equipment (UE) or an electronic device (ED). In some embodiments, processing unit 102 may be a Machine Type Communications (MTC) device (also referred to as a machine-to-machine (m2m) device), or another such device that may be categorized as a UE despite not providing a direct service to a user. In some references, the processing unit 102 may also be referred to as a mobile device (MD), a term intended to reflect devices that connect to mobile network, regardless of whether the device itself is designed for, or capable of, mobility.

The CPU 104 may comprise any type of electronic data processor. Thus the CPU 104 may be provided as any suitable combination of: one or more general purpose micro-processors and one or more specialized processing cores such as Graphic Processing Units (GPUs) or other so-called accelerated processors (or processing accelerators). The memory 108 may comprise any type of non-transitory system memory such as static random access memory (SRAM), dynamic random access memory (DRAM), synchronous DRAM (SDRAM), read-only memory (ROM), or a combination thereof. In an embodiment, the memory 108 may include ROM for use at boot-up, and DRAM for program and data storage for use while executing programs. The bus 106 may be one or more of any type of several bus architectures including a memory bus or memory controller, a peripheral bus, or a video bus. In an alternative embodiment the memory 108 may include types of memories other than ROM for use at boot up, as well as types of memory other than DRAM for program and data storage.

The mass storage 110 may comprise any type of non-transitory storage device configured to store data, programs, and other information and to make the data, programs, and other information accessible via the bus 106. The mass storage 110 may comprise, for example, one or more of a solid state drive, hard disk drive, a magnetic disk drive, or an optical disk drive.

The video adapter 112 and the I/O interface 114 provide optional interfaces to couple external input and output devices to the processing unit 102. Examples of input and output devices include a display 116 coupled to the video adapter 112 and an I/O device 118 such as a touch-screen coupled to the I/O interface 114. Other devices may be coupled to the processing unit 102, and additional or fewer interfaces may be utilized. For example, a serial interface such as Universal Serial Bus (USB) (not shown) may be used to provide an interface for an external device.

The processing unit 102 may also include one or more network interfaces 120, which may comprise wired links, such as an Ethernet cable, and/or wireless links to access one or more networks 122. The network interfaces 120 allow the processing unit 102 to communicate with remote entities via the networks 122. For example, the network interfaces 120 may provide wireless communication via one or more transmitters/transmit antennas and one or more receivers/receive antennas. In an embodiment, the processing unit 102 is coupled to a local-area network or a wide-area network for data processing and communications with remote devices, such as other processing units, the Internet, or remote storage facilities.

In some embodiments, electronic device 102 may be a standalone device, while in other embodiments electronic device 102 may be resident within a data center. A data center, as will be understood in the art, is a collection of computing resources (typically in the form of servers) that can be used as a collective computing and storage resource. Within a data center, a plurality of servers can be connected together to provide a computing resource pool upon which virtualized entities can be instantiated. Data centers can be interconnected with each other to form networks consisting of pools computing and storage resources connected to each by connectivity resources. The connectivity resources may take the form of physical connections such as Ethernet or optical communications links, and may include wireless communication channels as well. If two different data centers are connected by a plurality of different communication channels, the links can be combined together using any of a number of techniques including the formation of link aggregation groups (LAGs). It should be understood that any or all of the computing, storage and connectivity resources (along with other resources within the network) can be divided between different sub-networks, in some cases in the form of a resource slice. If the resources across a number of connected data centers or other collection of nodes are sliced, different network slices can be created.

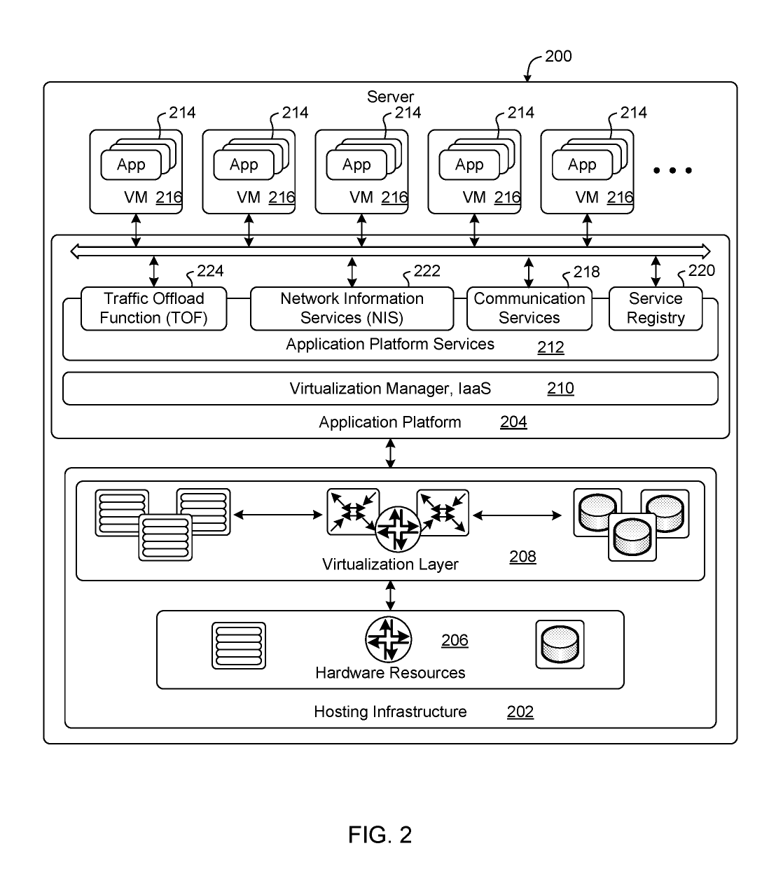

FIG. 2 is a block diagram schematically illustrating an architecture of a representative server 200 usable in embodiments of the present invention. It is contemplated that the server 200 may be physically implemented as one or more computers, storage devices and routers (any or all of which may be constructed in accordance with the system 100 described above with reference to FIG. 1) interconnected together to form a local network or cluster, and executing suitable software to perform its intended functions. Those of ordinary skill will recognize that there are many suitable combinations of hardware and software that may be used for the purposes of the present invention, which are either known in the art or may be developed in the future. For this reason, a figure showing the physical server hardware is not included in this specification. Rather, the block diagram of FIG. 2 shows a representative functional architecture of a server 200, it being understood that this functional architecture may be implemented using any suitable combination of hardware and software. It will also be understood that server 200 may itself be a virtualized entity. Because a virtualized entity has the same properties as a physical entity from the perspective of another node, both virtualized and physical computing platforms may serve as the underlying resource upon which virtualized functions are instantiated.

As maybe seen in FIG. 2, the illustrated server 200 generally comprises a hosting infrastructure 202 and an application platform 204. The hosting infrastructure 202 comprises the physical hardware resources 206 (such as, for example, information processing, traffic forwarding and data storage resources) of the server 200, and a virtualization layer 208 that presents an abstraction of the hardware resources 206 to the Application Platform 204. The specific details of this abstraction will depend on the requirements of the applications being hosted by the Application layer (described below). Thus, for example, an application that provides traffic forwarding functions may be presented with an abstraction of the hardware resources 206 that simplifies the implementation of traffic forwarding policies in one or more routers. Similarly, an application that provides data storage functions may be presented with an abstraction of the hardware resources 206 that facilitates the storage and retrieval of data (for example using Lightweight Directory Access Protocol-LDAP). The virtualization layer 208 and the application platform 204 may be collectively referred to as a Hypervisor.

The application platform 204 provides the capabilities for hosting applications and includes a virtualization manager 210 and application platform services 212. The virtualization manager 210 supports a flexible and efficient multi-tenancy run-time and hosting environment for applications 214 by providing Infrastructure as a Service (IaaS) facilities. In operation, the virtualization manager 210 may provide a security and resource “sandbox” for each application being hosted by the platform 204. Each “sandbox” may be implemented as a Virtual Machine (VM) 216, or as a virtualized container, that may include an appropriate operating system and controlled access to (virtualized) hardware resources 206 of the server 200. The application-platform services 212 provide a set of middleware application services and infrastructure services to the applications 214 hosted on the application platform 204, as will be described in greater detail below.

Applications 214 from vendors, service providers, and third-parties may be deployed and executed within a respective Virtual Machine 216. For example, MANagement and Orchestration (MANO) functions and Service Oriented Network Auto-Creation (SONAC) functions (or any of Software Defined Networking (SDN), Software Defined Topology (SDT), Software Defined Protocol (SDP) and Software Defined Resource Allocation (SDRA) controllers that may in some embodiments be incorporated into a SONAC controller) may be implemented by means of one or more applications 214 hosted on the application platform 204 as described above. Communication between applications 214 and services in the server 200 may conveniently be designed according to the principles of Service-Oriented Architecture (SOA) known in the art.

Communication services 218 may allow applications 214 hosted on a single server 200 to communicate with the application-platform services 212 (through pre-defined Application Programming Interfaces (APIs) for example) and with each other (for example through a service-specific API).

A Service registry 220 may provide visibility of the services available on the server 200. In addition, the service registry 220 may present service availability (e.g. status of the service) together with the related interfaces and versions. This may be used by applications 214 to discover and locate the end-points for the services they require, and to publish their own service end-point for other applications to use.

Mobile-edge Computing allows cloud application services to be hosted alongside mobile network elements, and also facilitates leveraging of the available real-time network and radio information. Network Information Services (NIS) 222 may provide applications 214 with low-level network information. For example, the information provided by MS 222 may be used by an application 214 to calculate and present high-level and meaningful data such as: cell-ID, location of the subscriber, cell load and throughput guidance.

A Traffic Off-Load Function (TOF) service 224 may prioritize traffic, and route selected, policy-based, user-data streams to and from applications 214. The TOF service 224 may be supplied to applications 224 in various ways, including: A Pass-through mode where (uplink and/or downlink) traffic is passed to an application 214 which can monitor, modify or shape it and then send it back to the original Packet Data Network (PDN) connection (e.g. 3GPP bearer); and an End-point mode where the traffic is terminated by the application 214 which acts as a server.

As may be appreciated, the server architecture of FIG. 2 is an example of Platform Virtualization, in which each Virtual Machine 216 emulates a physical computer with its own operating system, and (virtualized) hardware resources of its host system. Software applications 214 executed on a virtual machine 216 are separated from the underlying hardware resources 206 (for example by the virtualization layer 208 and Application Platform 204). In general terms, a Virtual Machine 216 is instantiated as a client of a hypervisor (such as the virtualization layer 208 and application-platform 204) which presents an abstraction of the hardware resources 206 to the Virtual Machine 216.

Other virtualization technologies are known or may be developed in the future that may use a different functional architecture of the server 200. For example, Operating-System-Level virtualization is a virtualization technology in which the kernel of an operating system allows the existence of multiple isolated user-space instances, instead of just one. Such instances, which are sometimes called containers, virtualization engines (VEs) or jails (such as a “FreeBSD jail” or “chroot jail”), may emulate physical computers from the point of view of applications running in them. However, unlike virtual machines, each user space instance may directly access the hardware resources 206 of the host system, using the host systems kernel. In this arrangement, at least the virtualization layer 208 of FIG. 2 would not be needed by a user space instance. More broadly, it will be recognised that the functional architecture of a server 200 may vary depending on the choice of virtualisation technology and possibly different vendors of a specific virtualisation technology.

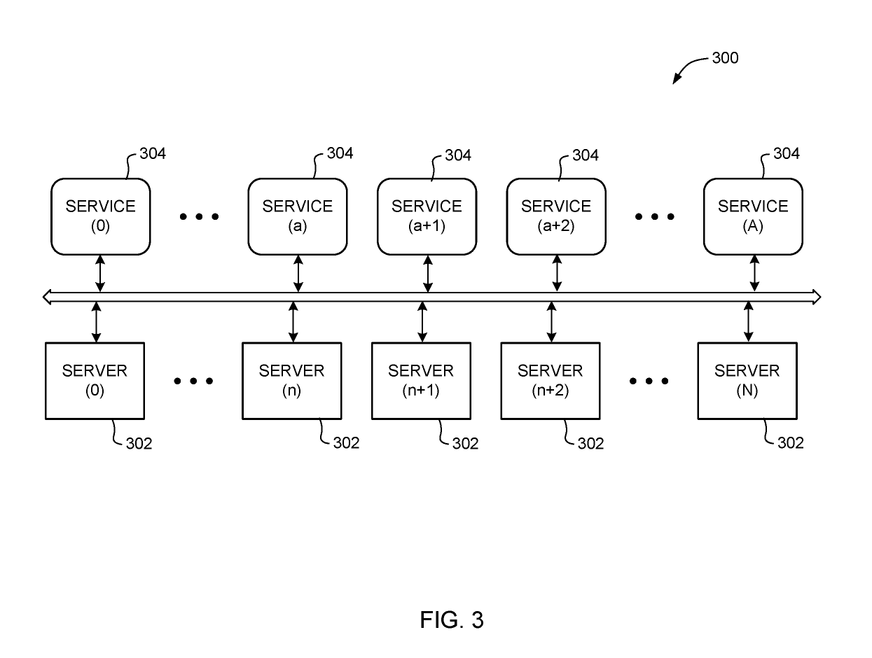

FIG. 3 is a block diagram schematically illustrating an architecture of a representative data center 300 in which embodiments of the present invention may be employed. As maybe seen in FIG. 3, the illustrated data center 300 generally comprises a plurality of servers 302 supporting a plurality of services 304. It is contemplated that each server 302 may be physically implemented in accordance with the server 200 described above with reference to FIG. 2, and may be interconnected with other servers 302 of the data center 300 to form a local network or cluster. Example servers 302 of the data center 300 may include: general purpose servers such as CPU and data storage; a server with NVIDIA K80 GPU; a server with Xilinx VU9P FPGA; and a server with 3GPP 5G fronthaul network connections. In addition, a server 302 may be provided as a virtual server implemented by a set of applications 214 executing on another server (which may itself be either a physical server or another virtual server), and having an allocation of physical resources of the data center. Those of ordinary skill will recognize that there are many suitable combinations of hardware and software that may be used for the purposes of the present invention, which are either known in the art or may be developed in the future. For this reason, a figure showing the physical hardware of the data center 300 is not included in this specification. Rather, the block diagram of FIG. 3 shows a representative functional architecture of a data center 300, it being understood that this functional architecture may be implemented using any suitable combination of hardware and software.

Each service 304 may comprise one or more applications 214 executing on at least one server 302. In some embodiments, a service 304 may be implemented by applications 214 executing on more than one server 302. A service 304 may be a virtual network function, or it may be a web service or something else that runs in a data center using data center resources. Example services 304 may include: virtual network functions such as Software Defined Networking (SDN), Firewall services, Load Balancing services, or a 3GPP 5G Serving gateway; Virtual Storefront services; and Video Streaming services. For the purposes of this disclosure, it is contemplated that each service either includes, or is associated with a corresponding management function configured to perform management operations on behalf of the service, as will be described in greater detail below.

In specific embodiments, a service instance may comprise a particular instantiation of the service in respect of a particular client, such as, for example, a particular network slice. In some embodiments, the corresponding management function included or associated with each service may be a Service Management Function (SMF)

As noted above, both a server 302 and a service 304 may be implemented by a set of applications 214 executing on another server. However, even in such a scenario, servers 302 and services 304 are distinguished from each other by the fact that servers 302 “own” resources of the data center, while services 304 must obtain an allocation of resources from a server 302 in order to operate.

For the purposes of this disclosure, it is useful to consider a “service volume” as an abstraction that may be used to describe the relationship between service requirements and data center resources For example, a service 304 may have a requirement for a defined data processing rate. This requirement may be satisfied by an allocation of 3 CPUs and 8 GBytes of memory to the service. By describing the relationship between the service requirement (for data processing speed) and data center resources (3 CPUs and 8 GBytes of memory), the concept of “service volume enables a service 304 (or its associated management function) to assess the sufficiency of data center resources allocated to it (or its placement), for example. Service volume may be specific to each service and allow conversion between service requirements and data center resources.

Service requirements may be defined as part of a service level agreement negotiated by a service provider, for example. Representative service requirements may include any one or more of: maximum or minimum data processing rates; maximum or minimum latency, maximum or minimum data transmission rates, etc.). Example service volume parameters may include: CPUs of data processing capacity, GBytes of memory; and Gbits per second data transmission rate on a given network interface. In some embodiments, a “CPU” of data processing capacity may be defined as a proportion of the processing capacity of a single processor 104. In some embodiments, a “CPU” may be defined as a predetermined amount of data processing capacity, which may be different from the processing capacity of a single processor 104. For example, a data center 300 may include servers 302 from multiple different vendors, and comprise processors having respective different data processing capacities. In such a case, it may be convenient to define a “CPU” as a predetermined amount of data processing capacity which corresponds with that of the least powerful processor 104 in the data center. Servers having more powerful processors would then be able to allocate CPU resources at a rate or more than one “CPU” per processor 104.

For the purposes of this disclosure, it is useful to consider a “placement” as the set of servers that have allocated resources to a specific service. For example, within a given placement, each server may execute applications of a respective service. More generally, within a given placement, each server may provide any one or more of: application hosting, traffic forwarding, and data storage for a respective service. It is contemplated that there will be a one-to-one relationship between services and placements, so that each service 304 is uniquely associated with a respective placement. Defining a placement separately from its service is beneficial in that it enables management of a placement (for example by a service management function) independently from its associated service or its associated service instances.

For the purposes of this disclosure, it is useful to consider a “resource allocation” as the set or resources (whether those resources are physical resources, or other services) that a server has allocated to a given service (or placement). More generally, resources allocated to a given service (or placement) may be physical resources, virtualized resources, services or other functions. In some embodiments, resources may be allocated in increments of a defined granularity. For example, memory may be allocated to (or de-allocated from) placements in units of 1 Gbyte, and data transmission bandwidth may be allocated to (or de-allocated from) placements in units of 1 Gbit per second. In some embodiments, resources may be considered as having a defined unit size, which may be partially allocated to a placement. For example, a whole unit of data processing capacity (i.e. a “CPU”) may represent a defined amount of data processing power, which may be sub-divided and allocated to different placements. As may be appreciated, the defined amount of data processing power comprising a whole unit of CPU capacity may be quantified an any suitable manner such as, for example, floating point operations per second.

In accordance with embodiments of the present invention, self organization of the data center 300 is accomplished by configuring each service 304 (or its associated management function) to select and modify its placement; and by configuring each server 302 (or an associated server management function) to select and modify its resource allocation to each service 304 (or placement).

In some embodiments, a service 304 may be provided with information identifying each server 302 within its placement. In specific embodiments, a service 304 may also be provided with information identifying the respective resource allocation of each server 302 within its placement. In other embodiments, information identifying servers 302 and/or resource allocations within a given placement may be provided to a service management function, rather than the service 304 itself. In such cases, the respective resource allocations of each server 302 within a placement may be aggregated together and presented to the service 304 as a single set of (virtualized) resources. Thus, for example, the service 304 may be presented (via a Virtualization Manager 210, for example) with a resource allocation comprising 3 CPUs, 8 GBytes of memory and 1 Gbits per second data rate on a given network interface, with little or no information regarding where these resources are resident within the data center 300. This resource allocation may then be shared between each service instance hosted by the Virtualization Manager 210, for example

In specific embodiments, a service 304 (or its associated management function) may select and modify its placement (for example when a particular service instance is created or removed) by means of a Stochastic Local Search (SLS). The Stochastic Local Search is known, for example, from Hoos & Stutzle, “Stochastic Local Search: Foundations and Applications”, 1st ed., Morgan Kaufmann; Sep. 30, 2004, ISBN-10: 1558608729

In general terms, a Stochastic Local Search (SLS) is a state based, randomized search algorithm that uses “local information” to make decisions. The SLS algorithm may have the following components:
set of candidate solutions S;
A set of feasible solutions, S⊆S;
A neighborhood relation that identifies the neighbors of a specific solution;
An initialization function;
A transition function that assigns a probability distribution to each neighbor of a specific solution, which may be used to decide which neighbors to consider; and
A termination predicate that tells the algorithm whether or not to terminate based on each solution. In other words, a termination predicate that controls termination of the SLS algorithm based on each solution

In the present disclosure, each solution S, S′ may represent a defined placement or a defined placement modification. The use of “local information” means that the SLS is performed based on information that is locally available to a particular service). Thus, for example, Service A (or its management function) will perform an SLS without considering information defining the respective placements of other services, because that information is not locally available to Service A.

In specific embodiments, each server (or an associated server management function) may select and modify its resource allocation to each service (or placement) by using an auction based on Algorithmic Game Theory. Algorithmic Game Theory auctions are known, for example, from Nisan, Roughgarden, Tardos & Vazirani, “Algorithmic Game Theory”; Cambridge University Press; 1 edition (Sep. 24 2007); ISBN-10: 0521872820. Game theory is the study of mathematical models of conflict and cooperation between intelligent rational decision makers. Since each service (or its associated management function) can be strictly rational, the principles of Game Theory may be applicable to the problem of finding a satisfactory resource allocation for each one of a plurality of services (or placements), which may otherwise be competing for resources of one or more servers.

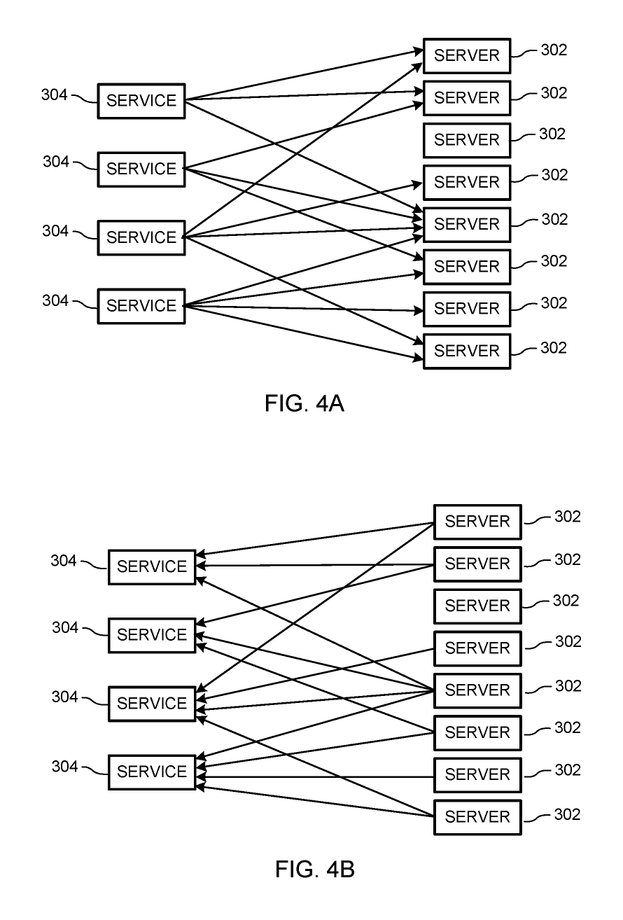

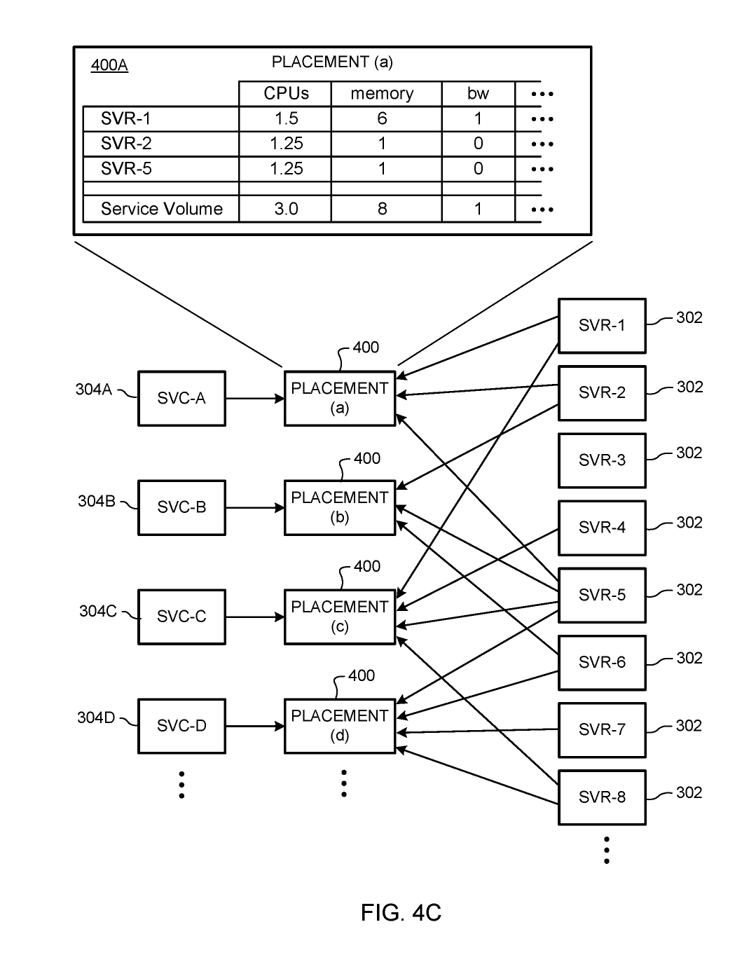

FIG. 4A and 4B illustrate the above-described relationships between Services 304 and their placements, and between Servers 302 and their resource allocations. FIG. 4A shows that Services 304 control their placements, while FIG. 4B shows that Servers 302 control their resource allocations. FIG. 4C illustrates the above-described relationships in greater detail. As may be seen in FIG. 4C, each service 304 is associated with a respective placement 400, and may control that placement 400 either directly or via a service management function. Similarly, each server 302 may participate in any one or more of the placements 400, and may allocate any of its resources to each placement 400 of which it is a member. FIG. 4C illustrates an example placement 400A, comprising three servers (SVR-1, SVR-2 and SVR-5), each of which has allocated resources to the placement. In the illustrated example, SVR-1 has made a resource allocation to the placement of 1.5 CPUs, 6 units of memory, and 1 unit of data transmission bandwidth; while both of SVR-2 and SVR-5 have made resource allocations of 1.25 CPUs, 1 unit of memory, and 0 unit of data transmission bandwidth. These resource allocations may be aggregated together to define a total service volume of 3 CPUs; 8 units of memory, and 1 unit of data transmission bandwidth. This service volume may be compared (either by the service or a service management function operating on behalf of the service) to the resource requirements of the service to determine whether or not changes in the placement may be beneficial.

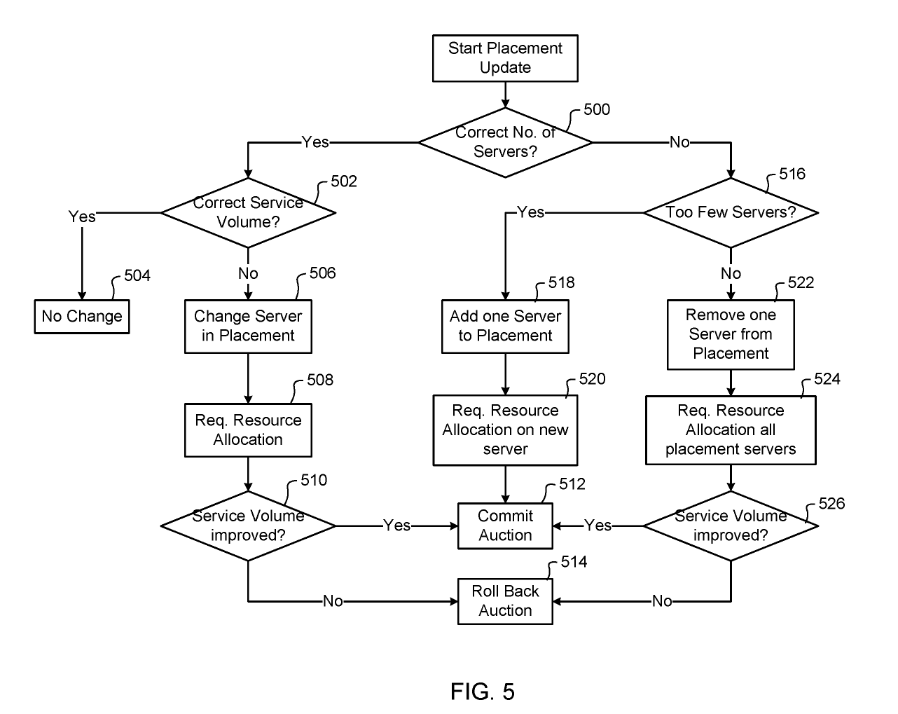

FIG. 5 is a flow chart illustrating an example process for implementing an SLS in respect of a given service. At step 500 the service determines whether or not its placement includes a correct number of Servers. If it does, then the service determines (at 502) if the Service Volume is correct. If it is, then no change in the placement is needed (504), and the process ends. Otherwise, the service chooses (at 506) a server change in the placement. For example, the service may select a server to be removed from the placement and also select a new server to be added to the placement in place of the server to be removed. The server to be removed from the placement may be selected according to any suitable criteria, such as, for example, one or more performance metrics or a random selection. In an alternate embodiment, the new server to be added to the placement may be selected according to any suitable criteria. In specific embodiments, the new server may be randomly selected from a set of candidate servers which may correspond with the set S′ of feasible solutions of the SLS. Then, the service requests (at 508) a resource allocation from the new server. This request triggers the new server to conduct an auction among all of the services that include that server in their respective placements. When the service receives the auction result, it determines (at 510) whether or not the service volume has been improved. The determination of whether or not the service volume has been improved is necessarily made relative to the service volume prior to the change in the placement, but may otherwise be based on any suitable criteria. For example, one or more performance metrics may be used for this purpose. Alternatively, the service volume may be considered to have been improved if a correspondence between a resource requirement of the service and the new service volume has improved. If the service volume has been improved, then the service sends a message to the new server to commit the auction (at 512). This causes the new server to establish the new resource allocation, and confirms the new server's membership in the service's placement. On the other hand, if the service volume has not improved, the service may send a message to the new server to roll back the auction (at 514), which returns the resource allocation(s) of that server to their previous state. The service may then return to step 506 to select another change in the placement. This process may then iterate until a placement change is found that improves the Service Volume.

Returning to step 500, if the number of servers is not correct, the service may determine (at 516) whether or not the placement includes too few servers. If it does, then the service may select a new server to add (at 518) to its placement. Here again, the new server may be randomly selected from a set of candidate servers which may correspond with the set S′ of feasible solutions of the SLS. Then, the service requests (at 520) a resource allocation from the new server. This request triggers the new server to conduct an auction among all of the services that include that server in their respective placements. When the service receives the auction results from the server, it may send a message to the new server to commit the auction (at 512). This causes the new server to establish the new resource allocation, and confirms the new server's membership in the service's placement.

Returning to step 516, if the placement does not include too few servers, then the service may select a server to be removed (at 522) from the placement. Then, the service requests (at 524) a new (or updated) resource allocation from each of the servers that remain within the placement. This request triggers each server of the placement to conduct an auction among all of the services that include that server in their respective placements. When the service receives the auction results from all of the servers in its placement, it determines (at 526) whether or not the service volume has been improved. If it has, then the service sends a message to the servers to commit the auction (at 512). This causes the servers to establish the new resource allocation. On the other hand, if the service volume has not improved, the service may send a message to each server to roll back the auction (at 514), which returns the resource allocation(s) of that server to their previous state. The service may then return to step 522 to select another server to remove from its placement. This process may then iterate until a change is found that improves the Service Volume.

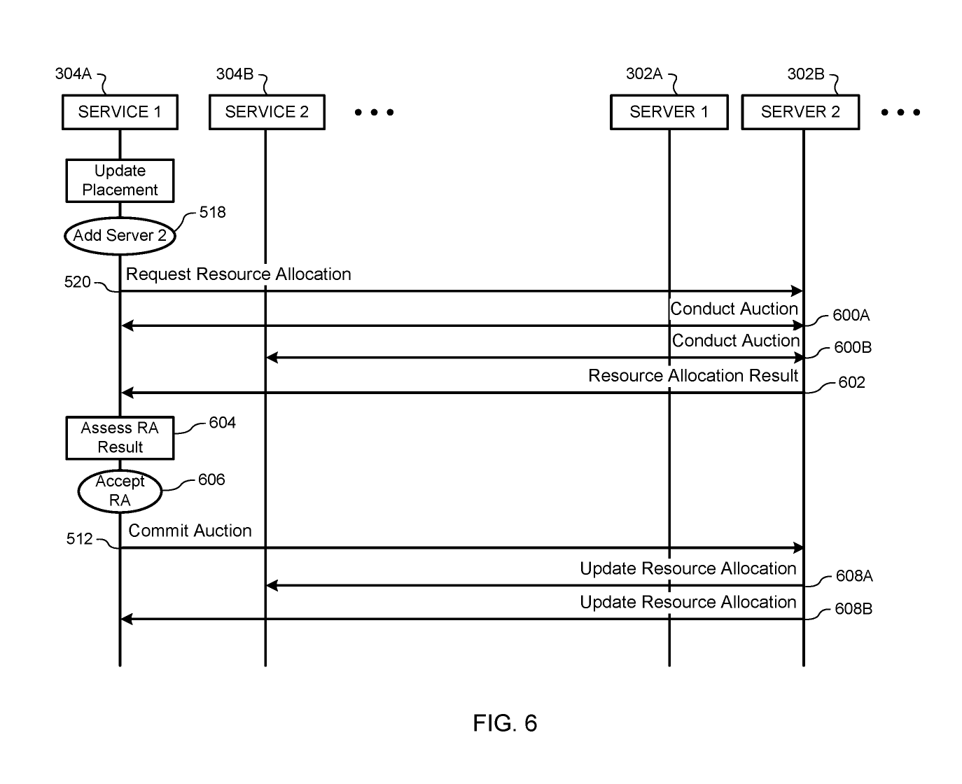

FIG. 6 is a call flow diagram illustrating an example process, which corresponds with steps 518-520-512, described above. In the scenario of FIG. 6, it is assumed that Service 2 already includes Server 2 in its placement, and so has a resource allocation from that server. As a result of Service l's placement update procedure (FIG. 5), Service 1 may select (at 518) to add Server 2 to its placement. Accordingly, Service 1 will send a message (at 520) to Server 2 requesting a Resource Allocation. In response to the request message from Service 1, Server 2 may conduct an Algorithmic Game Theory based auction (at 600) with both Service 1 and Service 2, in order to identify a new resource allocation for both services. In some embodiments, the auction performed by each server may be tailored to the specific characteristics of that server, or one or more of the services that include that server in their placement. At the conclusion of the auction server 2 may then send a Resource Allocation Result message (at 602) to Service 1.

Upon receipt of the Resource Allocation Result message, Service 1 may assess the resource allocation result (at 604) and decide to accept it (at 606). Consequently, the Service 1 may send (at 512) a message to Server 2 to commit the auction. This causes Server 2 to establish the new resource allocation, and confirms Server 2′s membership in the Service 1′s placement. Following receipt of the auction commit message from Service 1, server 2 may send resource allocation update messages (at 608) to each of Service 1 and Service 2 to confirm their new resource allocations.

In some embodiments, resource allocation auctions may be facilitated by means of allocating a resource budget to each placement, and a cost for resource allocations. For example, a placement may be assigned (e.g. at the time a first service instance is instantiated) a resource budget of 10 units, which may be “spent” by the service to obtain the resource allocation its respective service instances need to operate. In specific embodiments, a placement may also be assigned (e.g. at the time the first service instance is instantiated) a credit account, which may be “borrowed” by the service. In some embodiments, borrowing from the credit account may enable a service to modify its placement. Similarly, a cost may be assigned to the resources of a server. In some embodiments, the cost of each resource (or resource unit) may increase as available resources of the server decrease. For example, a server having a large amount of available (i.e. un-allocated) resources may assign a low cost to those resources, while a server having a lower amount of available (i.e. un-allocated) resources may assign a relatively higher cost to those resources. The use of resource budgets and resource costs in this manner may facilitate load balancing across servers of the data center.

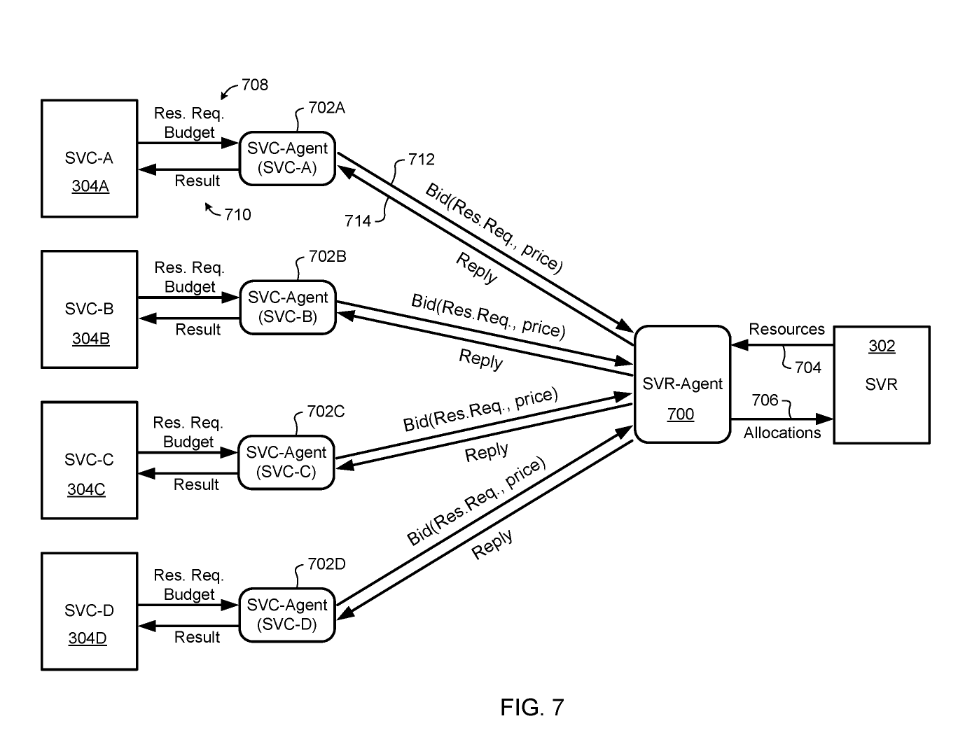

FIG. 7 illustrates representative messaging during the conduct of a resource auction. In the example illustrated in FIG. 7, the server 302 is represented by a respective server agent 700, which may be provided as a software entity instantiated by a management function associated with the server and configured with rules for conducting a resource auction. Similarly, each service is represented by a respective service agent 702, which may be provided as a software entity instantiated by a management function associated with the service 304 and configured with rules for participating in a resource auction. In some embodiments, each of the server agent 700 and service agents 702 may be referred to as “players”.

As may be seen in FIG. 7 at 704, the server agent 700 may receive (e.g. from the server 302 or a management function associated with the server) information of resources of the server 302 that may be allocated to one or more placements. This information may be used by the server agent 700 to limit resources allocated to each placement during the auction.

In some embodiments, the server agent 700 may also receive information identifying each service (or placement) to which resources of the server have been (or currently are) allocated. This information may be used by the server agent 700 to select participants in the auction. For example, the participants in an auction may be limited to the respective agent 702 of the service 304 requesting a new or changed resource allocation and the respective agents 702 of each service 304 to which resources of the server 302 are currently allocated.

At the conclusion of an auction, at 706 the server agent 700 may provide (e.g. to the server 302 or a management function associated with the server) information of resources allocated to each service or placement as a result of the auction. In some embodiments, the resources allocated to each service or placement as a result of the auction may be referred to as a “provisional allocation”, which may be either accepted or refused by one or more of the participating services, as will be described in greater detail below.

As may also be seen in FIG. 7 at 708, each service agent 702 may receive (e.g. from the service 304 or a management function associated with the service) information of a resource allocation requested by the service. For example, the service 304 or its management function may perform a Stochastic Local Search (SLS) to identify a proposed resource allocation to be requested from the server 302. Information defining this proposed resource allocation may be passed to the service agent 702, and may be used by the service agent 702 during the course of the resource auction, as will be described in greater detail below.

In some embodiments, each service agent 702 may also receive information of a budget that may be used by the service agent 702 during the course of the auction to bid for a resource allocation from the server, as will be described in greater detail below.

At the conclusion of an auction, at 710 the service agent 702 may provide (e.g. to the service 304 or its management function) information of a result of the auction. In some embodiments, this resource allocation auction result may comprise a provisional resource allocation granted to the service as a result of the auction.

During the course of an auction, each participating service agent 702 may send (at 712) a bid to the server agent 700. In some embodiments, the bid may include information of a resource allocation request and a bid price that the service agent 702 proposes to pay for the requested resource allocation.

Following receipt of a respective bid from each of the participating service agents 702, the server agent 700 may process the received bids to derive a respective provisional resource allocation for each service 304. Any suitable method may be used to derive a respective provisional resource allocation for each service 304. For example, if the total of the resource allocations requested in all of the received bids is less than the available server resources, then the server agent 700 may simply accept the various resources allocation requests, so that the respective provisional resource allocation for each service 304 is equal to their requested resource allocation. In another example, the server agent 700 may calculate a respective provisional resource allocation for each participating service agent 702 by allocating the available server resources among the participating service agents in proportion to the respective bid price included in each received bid. Once the provisional resource allocation for each service 304 has been calculated, the server agent 700 may send (at 714) the provisional resource allocation to the corresponding service agent 702.

In some embodiments, the resource allocation auction may be concluded when the server agent 700 has sent the provisional resource allocation to the participating service agents. In other embodiments, an auction may encompass two or more bid/reply cycles. Thus, for example, if a particular provisional resource allocation is less than that requested by a participating service agent 702, then the participating service agent 702 may submit a new bid with a higher bid price in an effort to obtain a larger provisional resource allocation. Conversely, if a particular provisional resource allocation is larger than that requested by a participating service agent 702, then the participating service agent 702 may submit a new bid with a lower bid price in an effort to obtain a smaller provisional resource allocation.

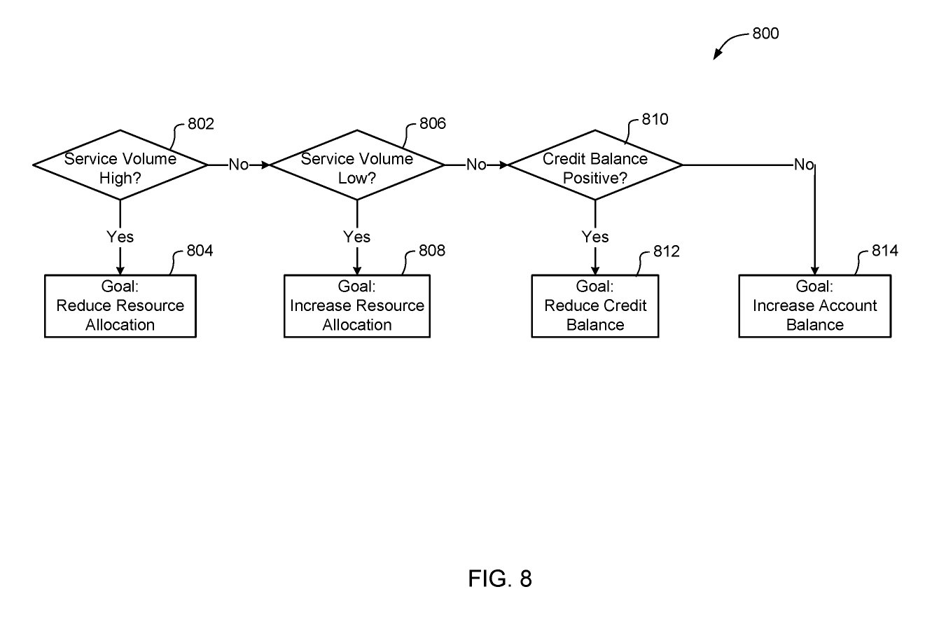

FIG. 8 is a flow-chart showing an example goal-seeking algorithm 800 of a type that may be implemented by a service 304 (or its service management function) to satisfy its resource requirements while minimizing costs. As may be seen in FIG. 8, the service 304 may evaluate the current service volume (at 802) to determine whether or not it is high. In this context, the service volume may be considered to be high if it is greater than the resource requirements of the service. For example, if a particular service instance is removed, then the service volume will exceed the resource requirements of the remaining service instances, and so will be “high”. In response to determining that the current service volume is high, the service 304 may trigger a modification of the placement (at 804) with a goal of reducing the resource allocation. Thus, for example, the service 304 (or its service management function) may attempt to reduce either one or both of: the number of servers in its placement, and the amount of resources allocated by any one or more of the servers in its placement.

If the service 304 determines that the current service volume is not high, the service 304 may then evaluate the current service volume (at 806) to determine whether or not it is low. In this context, the service volume may be considered to be low if it is less than the resource requirements of the service instance. For example, if a new service instance is added, then the service volume will not meet the resource requirements of the current service instances, and so will be “low”. In response to determining that the current service volume is low, the service 304 may trigger a modification of the placement (at 808) with a goal of increasing the resource allocation. Thus, for example, the service 304 (or its service management function) may attempt to increase either one or both of: the number of servers in its placement, and the amount of resources allocated by any one or more of the servers in its placement.

If the service 304 determines (at 802 and 806) that the current service volume is neither high nor low, the service 304 may then evaluate its credit account (at 810) to determine whether or not it has a positive credit balance that needs to be repaid. In response to determining that there is a positive credit balance that needs to be repaid, the service 304 may operate (at 812) with a goal of reducing is credit balance. Thus, for example, the service 304 (or its service management function) may use a positive balance in its budget account to repay at least a portion of the credit account. Alternatively, the service 304 (or its service management function) may attempt to identify alternative resource allocations (perhaps on different servers) that can satisfy its resource requirements at lower cost.

In response to determining that there is no positive credit balance that needs to be repaid, the service 304 may operate (at 814) with a goal of increasing its account balance. Thus, for example, the service 304 (or its service management function) may attempt to identify alternative resource allocations (perhaps on different servers) that can satisfy its resource requirements at lower cost.

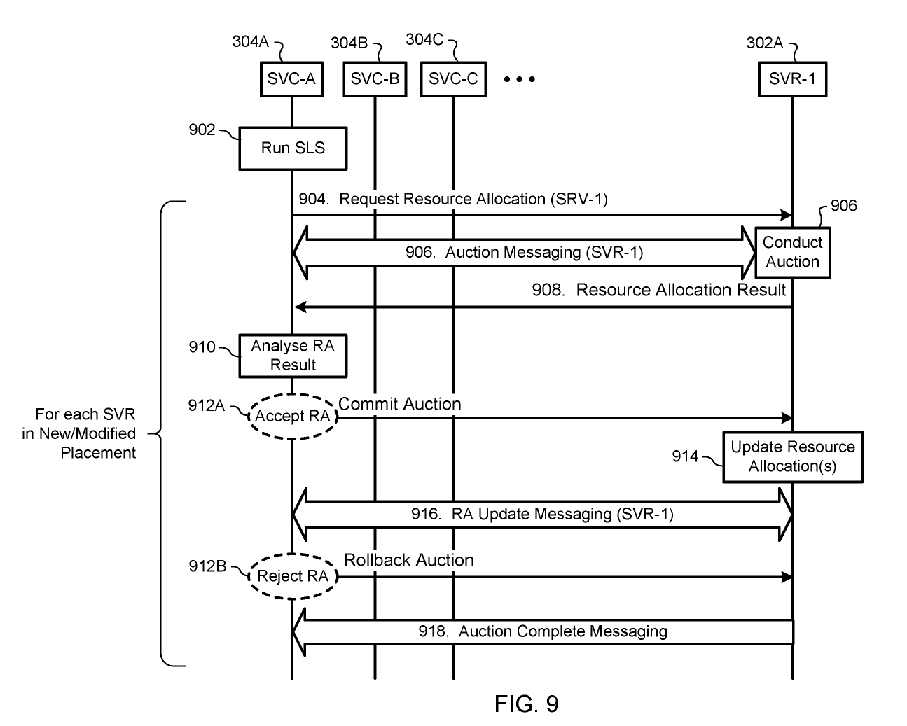

FIG. 9 is an example message flow diagram of a type which may be implemented by the service 304 (or its service management function) at any of steps 804, 808, 812 or 814 to modify its placement in an attempt to optimize its service volume at minimum cost. Principle steps in the process of FIG. 9 are as follows:

Step 902: The service 304 (or its service management function) may run a Stochastic Local Search (SLS) to identify a feasible solution S′ that may meet a desired goal. In some embodiments, the feasible solution S′ may define a possible placement, which may, for example, include information defining a set of one or more servers and respective proposed resource allocations for each server. In other embodiments, the feasible solution S′ may comprise a possible modification of the service's existing placement, which may, for example, include information defining at least one server and a respective proposed new resource allocation for that server. In some embodiments, the feasible solution S′ may be selected from among one or more neighbor solutions of the service's existing placement.

Preferably, the feasible solution S′ is selected to meet the applicable goal of the service. For example, if the processing at step 802 of FIG. 8 determines that the service volume is high, then the service (or its service management function) may operate (at step 804) with a goal to reduce its resource allocation. In this case, the SLS (step 902) may be run to identify a feasible solution S′ that has (or results in) a lower service volume than the service's existing placement. Similarly, if the processing at step 806 of FIG. 8 determines that the service volume is low, then the service (or its service management function) may operate (at step 808) with a goal to increase its service volume. In this case, the SLS (step 902) may be run to identify a feasible solution S′ that has (or results in) a higher service volume than the service's existing placement. As noted above, in both of steps 812 and 814, the service (or its service management function) may operate with a goal to reduce the total cost of its placement. In such a case, the SLS (step 902) may be run to identify a feasible solution S′ that has (or results in) a lower total cost than the service's existing placement.

It is contemplated that the SLS (step 902) may identify a set of two or more feasible solutions S′ that may be predicted to meet the applicable goal. In such a case, one solution may be selected from the identified set of feasible solutions S′ in accordance with any suitable criteria. For example, a lowest cost solution may be selected. Alternatively, a solution having a highest probability of meeting the applicable goal may be selected.

Step 904: Based on the identified feasible solution the service (or its service management function) may send a resource allocation request to a selected server identified in the feasible solution. In the illustrated example, the resource allocation request is sent by the service SVC-1 304A (or its service management function) to Server 1 302A. In some embodiments, the resource allocation request message may include information identifying the respective proposed resource allocation of that server. Thus, in the example of FIG. 9, the resource allocation request may include a proposed resource allocation to SVC-1's placement. It is contemplated that step 904 and the subsequent steps (906-918) described below will be repeated for each server identified in the selected feasible solution.

Step 906. In response to the resource allocation request, the server 302A (or its service management function) may initiate an Algorithmic Game Theory (AGT) resource allocation auction to determine the allocation of resources to each placement supported by the server. In some embodiments, the resource allocation auction may be conducted as described above with reference to FIG. 7, and so involve messaging between the server (and its server agent 700) and each of the services 304 (or their respective service agents 702) to which the server 302A has allocated resources.

Step 908: At the conclusion of the resource allocation auction (step 906) the service SVC-1 304A (or its service management function) receives a resource allocation auction result, which may comprise a provisional resource allocation of the server 302A. In the example of FIG. 9, the resource allocation result is forwarded to the service SVC-1 by the server 302A. In some embodiments, the resource allocation result may be forwarded to the service SVC-1 by the service agent 702, as described above with reference to FIG. 7 at 710.

Step 910: Following receipt of the resource allocation auction result, the service SVC-1 (or its service management function) may analyze the result, for example by comparing it to any one or more of: the goal of modifying its placement (as determined at any of steps 804, 808, 812 or 814); the selected feasible solution S′; and the requested resource allocation. Based on this analysis, the service SVC-1 (or its service management function) may decide to accept or reject the resource allocation auction result.

Step 912A: If the service SVC-1 (or its service management function) decides to accept the resource allocation auction result, it may send a “Commit Auction” message to the server 302A.

914-916: Upon receipt of the “Commit Auction” message from the service SVC-1 (or its service management function), the server 302A may implement the resource allocation result by updating its resource allocations to each placement. The server may then forward appropriate resource allocation update messages to each service to which the server has allocated resources, so as to inform each service (or its management function) of its new resource allocation. Thereafter, each involved service instance may continue to operate based on the updated resource allocations of the server.

Step 912B: If the service SVC-1 (or its service management function) decides to reject the resource allocation auction result, it may send a “Rollback Auction” message to the server 302A.

918: Upon receipt of the “Rollback Auction” message from the service SVC-1 (or its service management function), the server 302A may discard the resource allocation auction result, and send corresponding messages to each service to which the server has allocated resources, so as to inform each service (or its management function) that the auction has been completed with no change in resource allocation. Thereafter, each involved service instance may continue to operate based on the previous resource allocations of the server.

In the appended claims, references to “a service”, the “first service” and “other services” shall be understood to also refer to respective service management functions associated with the service. first service and other services.

It should be appreciated that one or more steps of the embodiment methods provided herein may be performed by corresponding units or modules. For example, a signal may be transmitted by a transmitting unit or a transmitting module. A signal may be received by a receiving unit or a receiving module. A signal may be processed by a processing unit or a processing module. Other steps may be performed by modules or functional elements specific to those steps. The respective units/modules may be implemented as specialized hardware, software executed on a hardware platform that is comprised of general purpose hardware, or a combination thereof. For instance, one or more of the units/modules may be implemented as an integrated circuit, such as field programmable gate arrays (FPGAs) or application-specific integrated circuits (ASICs). It will be appreciated that where the modules are software, they may be stored in a memory and retrieved by a processor, in whole or part as needed, individually or together for processing, in single or multiple instances as required. The modules themselves may include instructions for further deployment and instantiation.

Although the present invention has been described with reference to specific features and embodiments thereof, it is evident that various modifications and combinations can be made thereto without departing from the invention. The specification and drawings are, accordingly, to be regarded simply as an illustration of the invention as defined by the appended claims, and are contemplated to cover any and all modifications, variations, combinations or equivalents that fall within the scope of the present invention.

We claim:

1. A method of managing a data center, the method comprising:
a server of the data center receiving a request for a resource allocation from a first service instantiated by one or more applications executing in the data center;
responsive to the request from the first service, the server defining a respective new resource allocation for the first service, and providing a corresponding new resource allocation result to the first service.

2. The method as claimed in claim 1, wherein the server is selected by the first service, in accordance with a Stochastic Local Search.

3. The method as claimed in claim 1, further comprising steps of:
receiving a Commit Auction message from the first service, the Commit Auction message indicating that the first service accepts the new resource allocation result; and
responsive to the Commit Auction message, the server implementing the new resource allocation for the first service.

4. The method as claimed in claim 1, further comprising steps of:
receiving a Rollback Auction message from the first service, the Rollback Auction message indicating that the first service rejects the resource allocation result; and
responsive to the Rollback Auction message, the server discarding the new resource allocation for the first service.

5. The method as claimed in claim 1, wherein defining the resource allocation comprises the server defining the new resource allocation in accordance with an Algorithmic Game Theory based auction.

6. The method as claimed in claim 5, wherein the Algorithmic Game Theory based auction encompasses the first service and at least one other service to which resources of the server are allocated, and generates a respective new resource allocation for the first service and each of the at least one other service.

7. The method as claimed in claim 1, wherein defining a respective resource allocation for the first service further comprises defining a respective new resource allocation for at least one other service to which resources of the server are allocated.

8. The method as claimed in claim 7, further comprising steps of:
receiving a Commit Auction message from the first service, the Commit Auction message indicating that the first service accepts the new resource allocation result; and
responsive to the Commit Auction message, the server implementing the respective new resource allocation for the first service and the respective new resource allocation for each of the at least one other service.

9. A server configured to manage resources of a data center, the server comprising:
a non-transitory computer readable storage medium storing software instructions for controlling the server to:
receive a request for a resource allocation from a first service instantiated by one or more applications executing in the data center;
responsive to the request from the first service, define a respective new resource allocation for the first service; and
provide a corresponding new resource allocation result to the first service.

10. The server as claimed in claim 9, further configured to:
receive a Commit Auction message from the first service, the Commit Auction message indicating that the first service accepts the new resource allocation result; and
implement the new resource allocation for the first service.

11. The server as claimed in claim 9, further configured to:
receive a Rollback Auction message from the first service, the Rollback Auction message indicating that the first service rejects the new resource allocation result; and
discard the new resource allocation for the first service.

12. The server as claimed in claim 9, wherein defining the new resource allocation comprises defining the new resource allocation in accordance with an Algorithmic Game Theory based auction.

13. The server as claimed in claim 12, wherein the Algorithmic Game Theory based auction encompasses the first service and at least one other service to which resources of the server are allocated, and generates a respective new resource allocation for each of the first service and each of the at least one other service.

14. The server as claimed in claim 9, wherein defining a new respective resource allocation for the first service further comprises defining a respective new resource allocation for at least one other service to which resources of the server have been allocated.

15. The server as claimed in claim 14, further configured to:
receive a Commit Auction message from the first service, the Commit Auction message indicating that the first service accepts the new resource allocation result; and
responsive to the Commit Auction message, implement the respective new resource allocation for the first service and the respective new resource allocation for the at least one other service.
